(19) United States
(12) Patent Application Publication
(10) Pub. No.: US 2004/0016179 A1
(43) Pub. Date: Jan. 29, 2004

(54) Watering system

(76) Inventor: Christopher Raymond Moran, Dumbarton (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/415,529

(22) PCT Filed: Oct. 29, 2001
(86) PCT No.: PCT/GB01/04769

(51) Int. Cl. A01G 29/00

(52) U.S. Cl. 47/79; 47/48.5

(57) ABSTRACT

Apparatus for cultivating plants comprises a vessel (15) for receiving a plant cultivating medium (10), the vessel wall having a number of apertures (30) which are substantially covered over by a water-permeable polymer (35) which controls introduction of aqueous media (25) into the vessel (15). The vessel (15) and polymer (35) sit in a reservoir (20) for the aqueous media (25). The polymer (35) may be water-swellable and may be a hydrogel and preferably is in the form of a film, membrane, layer or sheet having a thickness in the range 0.001 mm to 5.0 mm. The polymer (35) supports transport of the aqueous media (25) through the thickness of the polymer (35) by diffusion so that entry of aqueous media (25) into the vessel (15) by hydraulic or capillary flow is prevented. The diffusion rate is self-controlled by the plant species.

The present invention relates to a plant irrigation system, in particular a hydrogel controlled plant irrigation system.

The sale of pot plants such as containered house plants is currently falling behind the increasingly growing market in cut flowers. Particular care, especially watering, is often required to keep pot plants alive and healthy. Modern lifestyles including long working hours and holiday periods contribute to periods of neglect, underwatering, overwatering and irregular watering cycles, including over feeding and under feeding regimes. This contributes to the problem of keeping pot plants alive and healthy. Similarly, such water control difficulties may affect propagation success when attempting to germinate seeds or root plant cuttings.

It is an object of the present invention to obviate and/or mitigate the abovementioned problems, in particular to provide a controlled irrigation system for pot plants, seeds or plant cuttings.

According to a first aspect of the present invention there is provided a vessel for cultivating plants which comprises one or more apertures of which one or more are substantially occluded by a water permeable polymer.

According to a further aspect of the present invention there is provided an apparatus for cultivating plants, which apparatus comprises a vessel for receiving a plant cultivating medium, the vessel wall having one or more apertures of which at least one is substantially occluded by a water permeable polymer for controllably introducing an aqueous medium into the vessel, and a reservoir for the aqueous medium.

In a further aspect of the present invention there is provided an irrigation system for cultivating plants, the irrigation system comprising a vessel suitable for containing a plant cultivating medium in cooperation with a reservoir for aqueous medium wherein said vessel comprises one or more apertures of which at least one aperture is substantially occluded by a water permeable polymer and the water permeable polymer is constructed and arranged to support transport of the aqueous medium through the thickness of the polymer by diffusion into the cultivating medium.

The present invention also provides an irrigation system comprising a vessel suitable for containing a plant cultivating medium wherein said vessel comprises one or more apertures of which one or more are substantially occluded by a water permeable polymer and, means for contacting water or an aqueous solution with said water permeable polymer to allow the water or aqueous solution to transfer across or through the water permeable polymer and through said apertures into the plant cultivating medium.

Typically, the vessel is a suitably provided plant cultivating container such as a plant pot.

Typical cultivating media are peat, soil, humus, compost based media or hydroponics cultivating media.

According to a further aspect of the present invention there is provided use of a water permeable polymer for transferring water or an aqueous solution across a partition into a plant cultivating medium.

The present invention may be used to irrigate most of the commonly available indoor plants. In particular, the present invention is suited for those plants which require constantly moist soil, particularly during their flowering and/or growing periods/seasons.

It is understood that any reference herein to water, water permeable, water transfer, aqueous medium, etc., also includes reference to any species which may be dissolved in the water, such as plant nutrients, which may be transferred together with the water.

The water permeable polymer is generally a water swellable polymer, in particular a hydrogel.

Preferred hydrogel materials are those which are non-porous or so-called “dense” hydrogels. Without wishing to be bound by theory, the absorbed water in these hydrogels tends to be an integral part of the swollen hydrogel molecular structure rather than being contained in open pores. However, although this type of hydrogel is preferred, porous polymers or hydrogels may be suitable for use in this invention as long as the pores have a suitably small dimension to allow diffusional transport of water and any dissolved species therein through the polymer, rather than via hydraulic flow, capillary action or wicking mechanisms or the like.

Preferred hydrogels are polyurethane hydrogels, in particular polyurethane urea hydrogels such as those described in U.S. Pat. No. 5,236,966 and European Patent No. 00691992B. These hydrogels are particularly desired because they are relatively strong, flexible and rubbery in the dry (non or un-swollen) and the wet (water-swollen) state.

More preferable hydrogels are polyurethane hydrogels similar to the compositions and methods described by European Patent No. 00691992B but without the use of a diamine component and containing up to 55% by weight of the hydrophilic component, poly(ethylene oxide). These PU hydrogel materials are also relatively strong, flexible and rubbery in the dry (non or un-swollen) and the wet (water-swollen) state and are advantageous in that the compositions are completely aliphatic and do not use potentially harmful and expensive diamines in the synthetic reaction. Completely aliphatic polyurethanes and polyurethane ureas are generally considered to be more stable and more biocompatible than equivalent polymers containing aromatic components. Additionally, polyurethanes are more thermoformable than corresponding polyurethane urea polymer compositions.

A typical polyurethane composition may be as follows:

PU6 (6200)

| Component | PEG6200 | PPG425 | Desmodur W |
|---|---|---|---|
| Moles | 1.0 | 10.0 | 11.55 |
| Weight Percent | 45.99 | 31.52 | 22.49 |

Where

PEG6200=Poly(ethylene glycol) with a molecular weight of 6200

PPG425=Poly(propylene glycol) with a molecular weight of 6200

Desmodur W=4,4′-Dicyclohexylmethane diisocyanate

The PU synthetic reaction may be a “one-shot” melt polymerisation carried out at 95° C. for a time period of 20 hours. The reaction is catalysed using anhydrous ferric chloride at a concentration of 0.02% by total weight of the reactants.

It is preferred that the water permeable polymer is provided as a film, membrane, layer, sheet or the like.

The thickness of the film, membrane etc. may be between about 0.001 mm to 5.0 mm, preferably 0.05 mm to 5.0 mm, more preferably 0.1 to 2.0 mm, desirably 0.5 mm to 1.0 mm.

Very thin films, membranes etc, for example those having a thickness below 0.05 mm to 0.1 mm may be difficult to handle and may be easily ruptured. Even thinner films, membranes etc, i.e those having a thickness in the range about 0.001 mm to about 0.05 mm may be formed as a coating on a porous or microporous support membrane, sheet etc which may provide mechanical integrity to the film, membrane etc.

In a preferred embodiment, the abovementioned film, membrane, layer, sheet or the like is typically positioned in intimate contact with the lower outer surface of a vessel base which contains holes which conventionally function as drainage holes. The film, membrane etc. is positioned to sufficiently form a seal against the surface of the vessel base. The seal may conveniently be maintained by the weight of the plant vessel impressing down upon the film, membrane etc. thus substantially occluding the drainage holes provided in the base of the vessel.

Such an effective seal formed against the surface of the vessel is important to prevent entry of water into the vessel through hydraulic or capillary flow between the film, membrane etc. and the surface of the vessel since water movement should substantially be controlled by diffusional processes only.

Use may also be made of glues, sealants such as rubber sealants, adhesives such as pressure sensitive adhesive, grease, such as silicon grease and the like to form a suitable seal between the film, membrane etc. and the vessel surface. The abovementioned glues etc. may conveniently be provided at the edge, perimeter or border of the film, membrane etc.

A suitable adhesive is an acrylic type double-sided pressure sensitive adhesive tape such as used in the medical industry for attaching heart monitor pads or for wound dressings, or as used for adhering external name-plates and signs, and protective laminate film on windows (e.g. window repair or ultra-violet light protection).

Particularly desirable adhesives are those which are is pressure sensitive that provide a suitable seal but allow the film, membrane etc. to be easily applied to the vessel and repeatedly removed and reapplied or repositioned or allow easy removal for replacement purposes.

A particularly good seal may be formed when the lower outer surface of the container has a flat and/or smooth surface and/or border, or perimeter.

In an alternative embodiment, the film, membrane etc. may be placed inside the vessel, to contact the lower inner surface of the base of the vessel.

Particularly desired hydrogels are polyurethane hydrogels, in particular polyurethane urea hydrogels such as those described in U.S. Pat. No.5,236,966 and European Patent No.0691992B1. These hydrogels are particularly desired because they are relatively strong, flexible and rubbery in the dry (non or un-swollen) and the wet (water-swollen) state.

Furthermore, polyurethane urea hydrogels may be formed into the abovementioned desirable shapes e.g. films, membranes, layers, sheets etc. using existing techniques which utilize heat and pressure, for example by utilising compression moulding or calendering techniques, or alternatively by casting from a suitable solution thereof.

The water permeable polymers described for use in the present invention may optionally be combined with fabric materials by using for example heat or glue laminating techniques to produce composite materials having improved strength and/or absorbency compared to the native polymer. Production of such composites may be achieved through use of continuous rolling and optionally heat laminating processes which may avoid use of potentially dangerous or environmentally harmful solvents.

In yet another embodiment, the water permeable polymer may be provided in a shaped form such that it conforms to the inside surface of the vessel. For example, the polymer may be provided in the form of a bag into which the cultivating medium can be placed. Use of such a bag may obviate the need for establishing a good seal between the vessel surface and polymer. Here, the vessel provides support, by containing, the bag.

Preferably, in the above described polymer-vessel assemblies, provision is made for the cultivating medium to either directly or indirectly contact the permeable polymer. This allows water to directly enter the cultivating medium on passage through the polymer. For example, if the polymer is positioned on the outer lower surface of the vessel, the cultivating medium may contact the polymer directly via holes which are conventionally provided as drainage holes provided in the base of the vessel.

The polymer may be used in combination with a layer of wicking fabric, porous substrate, such as an open celled foam or porous ceramic, granular material such as sand, gravel, or stones or a mesh platform or the like. The cultivating medium present in the vessel may thus be prevented from directly contacting the polymeric material by placing the abovementioned materials between the cultivating medium and the polymer. Entry of water into the cultivating medium will thus occur via entry into and then passage through these materials.

A convenient method for contacting water or an aqueous solution with the water permeable polymer, is to provide a reservoir surrounding the vessel. Water or aqueous solution may then reside in the reservoir. Thus the water will typically be positioned between the inner surface of the outer wall of the reservoir and the outer surface of the vessel. A convenient way of achieving this is to position the vessel within a larger vessel which acts as a reservoir.

Thus in use the water first contacts the water permeable polymer, which in turn allows the water to pass through it by substantially diffusional processes into the cultivating medium.

Without wishing to be bound by theory, it is believed that the transport mechanism of the water or aqueous solution through the polymer occurs by diffusion or permeation, driven by the difference in osmotic potential (chemical potential, water activity/potential, water and solute concentration) between the water or aqueous solution contained in the external reservoir and the osmotic potential (chemical potential, water activity/potential, water and solute concentration) of the cultivating medium. The transport of the water and/or aqueous species from the external reservoir into the cultivating medium is not by hydraulic flow through holes or pores, capillary flow or Dy a wicking mechanism but by diffusion or permeation through the membrane structure. Thus a restricted and hence controlled flow or supply of water is provided to the plant cultivating medium and hence to the plant growing therein. It is possible for the plant transpiration rate to maintain and control the osmotic potential difference (chemical potential, water activity/potential, concentration gradients) across the membrane barrier. The size of the external reservoir and the contained volume of water or aqueous solution can be varied to control the period of operation. Additionally the water economy of the system is such that the present invention may be useful in areas where water conservation and management is an important concern.

Conveniently projections may be provided on the base of the vessel to facilitate the positioning of the polymer, especially when it is in the form of a film, layer or sheet and additionally such projections may allow the container to be supported away from the lower reservoir surface on which it is standing thus allowing the water in the reservoir to freely access the base of the vessel and the polymer positioned on or adjacent thereto. In addition to, or instead of the projections, the vessel may be positioned on top of a wicking fabric, porous substrate, such as an open celled foam or porous ceramic granular material such as sand, gravel, or stones or a mesh platform or the like. Again these materials may facilitate the flow of water to the surface of the polymer by supporting the vessel away from the lower reservoir surface and/or by acting as water distribution means.

Any suitably sized outer reservoir vessel may be used such that one or more vessels can be accommodated within the outer reservoir vessel. In such a configuration, a size of film, membrane etc. larger than any individual vessel may be provided in the outer reservoir vessel such that several smooth based vessels may be placed upon the film, membrane etc.

The outer reservoir vessel may conveniently be formed from conventional plant pot drainage dishes, trays, saucers, bowls, decorative plant pot containers and covers or the like which may be made from any suitable material such as plastics, ceramics, metals or the like. Suitable covers may be provided over the reservoirs to reduce or prevent water loss through evaporation. Alternatively the upper lip of the reservoir vessel may be in-curled to reduce the exposed water surface area.

The size and shape of the outer reservoir vessel and the amount of water contained therein may affect the amount of water loss through evaporation and may be chosen to give different periods before re-filling the reservoir with water. The skilled person will also appreciate that the water usage rate from the reservoir will depend on various factors including the size of plant used, the plant transpiration rate and water usage requirements. The size of reservoir vessel and height of reservoir water may also influence the water usage rate, and also the particular film, membrane etc. structure, composition, area and thickness and number, size, shape and position of holes in the vessel. These factors may also affect the transport rates of any dissolved nutrients such as dissolved salts, systemic fungicides, insecticides and the like. The skilled person will appreciate that the determination of suitable parameters to give an acceptable water supply is within the ordinary skill.

Without wishing to be bound by theory, it is believed that the diffusional mass transport rate may be governed by a combination of several factors such as osmotic driving force (chemical potential difference, difference in water activity/potential, salt and other solute concentration gradients), the water content of the membrane, the exposed membrane area, the membrane thickness, the pressure difference across the membrane and the temperature.

The hydrogel film, membrane etc. is preferably used in a water swollen state, and may be supplied either in this state or in a dry or non-swollen state, ready for swelling by the user. Non-swollen hydrogel may not be completely anhydrous so that it may contain a certain proportion of water which is below that contained within the hydrogel when in use in accordance with the present invention.

Typically the user would swell a dry or non-swollen hydrogel film, membrane etc., and then optionally cut the swollen film, membrane etc. to the required size which may then be fixed to the underside of the base of a vessel.

A dry or non-swollen hydrogel film, membrane etc, may be supplied in a pre-cut state as a suitable size which after swelling with water attains a required dimension(s) or size.

A selection of pre-swollen hydrogel films may be supplied which are pre-sized to match the dimensions of a variety of vessels.

Preferably said pre-swollen hydrogel films, membranes etc. are sized to be larger than the dimensions of the vessel base such that hydrogel may be seen to protrude away from the outer edge of the vessel base. This may provide a particularly effective seal between the hydrogel film, membrane etc, surface and the vessel surface.

Such sizing is desirable to allow ease of vessel placement upon the hydrogel film, thus obviating the need for accurate alignment of the vessel with the hydrogel. Furthermore, accidental movement of the vessel relative to the hydrogel film, membrane etc is somewhat allowed because precise alignment is not needed.

Optionally, it may be desirable for the hydrogel film, membrane etc dimensions to conform to an internal bottom surface dimension of the external reservoir.

The pre-swollen hydrogel film may further optionally comprise a pressure sensitive adhesive on a surface thereof which is protected by a release liner.

Pre-swollen or dry or non-swollen hydrogel films may conveniently be packaged in an air-tight, water-tight container or bag which preferably is UV and/or light occlusive to prevent loss of water or ultra-violet light degradation. Such packaging may additionally prevent water loss from pre-swollen hydrogel films.

Suitable packaging is well known in the food and medical industries. The packaged hydrogel film may then be removed from the packaging, the release liner removed, if present, and the film positioned onto a vessel ready for placement in a larger reservoir vessel.

Appropriately sized pieces of wicking fabric, porous support or the like may also be supplied ready for use by a user.

According to a further aspect of the present invention there is provided a kit comprising:

a film, membrane, layer or sheet or non-swollen or water-swollen hydrogel packaged in a light occlusive package.

Said hydrogel may be further provided with an adhesive.

Preferably the package may be additionally air-tight and/or water-tight.

The package may be supplied with a piece of wicking fabric or porous support which optionally may be contained within the package.

The kit may further comprise a vessel, such as a plant pot suitably formed to receive said hydrogel film thereto.

In particular the lower outer surface of said plant pot desirably has a flat and/or smooth surface and/or border, or perimeter.

Said kit may further comprise a reservoir vessel.

Said kit may optionally comprise at least one plant and/or seeds.

Although the hydrogel films, in particular the polyurethane urea hydrogel films can withstand cycling between a substantially or fully swollen state and substantially or fully dry state, it is preferable for the hydrogel film to remain in contact with water at all times, so that it does not dry out appreciably. A swollen hydrogel film generally exhibits a dimensional difference compared to the same film in a dry state. The magnitude of this difference may depend on the water-swelling capacity of the particular polymer composition, e.g., the particular polyurethane urea composition. Typical dimensional swelling factors range from about 1.3 (containing about 60% water by weight) to about 3.0 (containing about 90% water by weight), although hydrogels having lower swelling capacities in the range containing about 10% by weight to about 60% by weight of water may be used. Such lower swelling capacity hydrogels may be useful in irrigation systems according to the present invention where lower water transport rates are required.

A substantially dry hydrogel film may have a smaller dimension compared to the swollen version and hence may be unusable due to breakage or interruption of the seal between the vessel surface and the hydrogel film. In such circumstances it may be appropriate to re-swell the hydrogel film with water, although the film alternatively may be replaced with a fresh, pre-swollen film.

It is estimated that the functional lifetime of the hydrogel films described in accordance with the present invention is in the range of about 2 months to about 1 year or even longer. For the film to remain effective, it should preferably remain tear and/or puncture free so that the seal is maintained between the film and vessel surface so that the diffusional flow of water as opposed to hydraulic or capillary flow is maintained.

Embodiments of the present invention will now be described by way of the following non-limiting examples, with reference to the accompanying drawings, in which

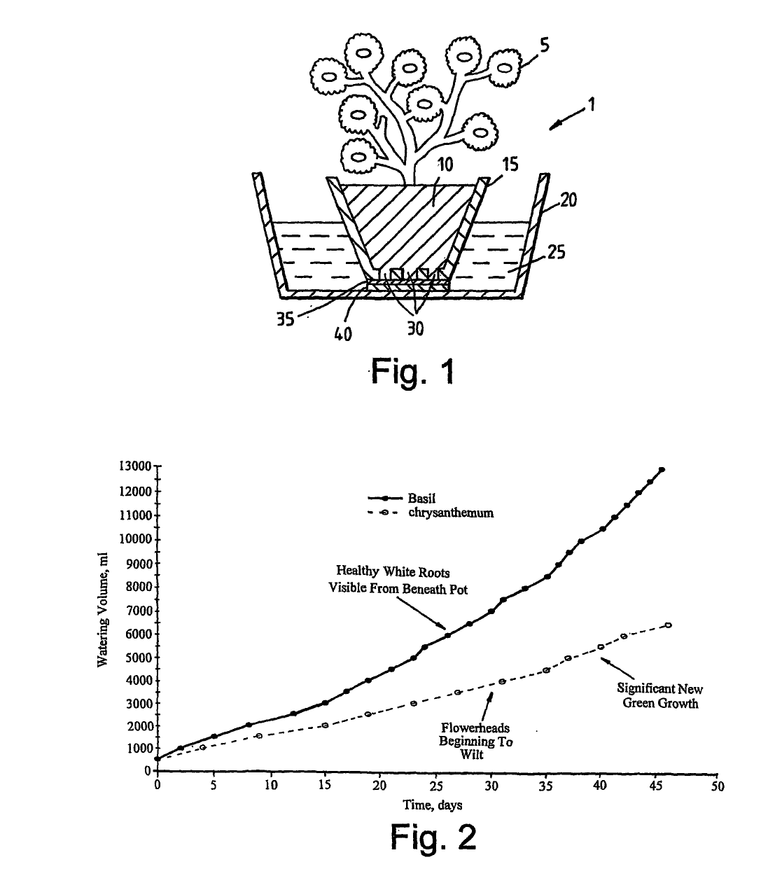

FIG. 1 shows an irrigation system in accordance with a preferred embodiment of the present invention for growing several varieties of plant;

FIGS. 2, 3 and 4 show graphs of results of plant growth using the system of FIG. 1;

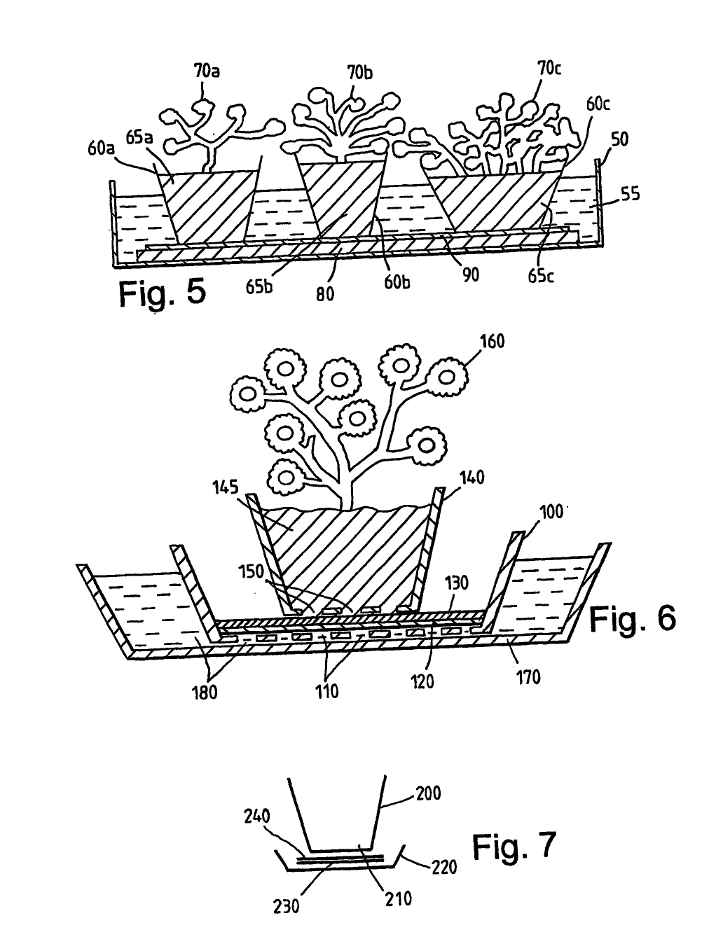

FIG. 5 shows a tray based irrigation system in accordance with an alternative embodiment of the present invention.

FIG. 6 shows an irrigation system in accordance with a further alternative embodiment of the present invention.

FIG. 7 shows a vessel in accordance with an embodiment of the present invention.

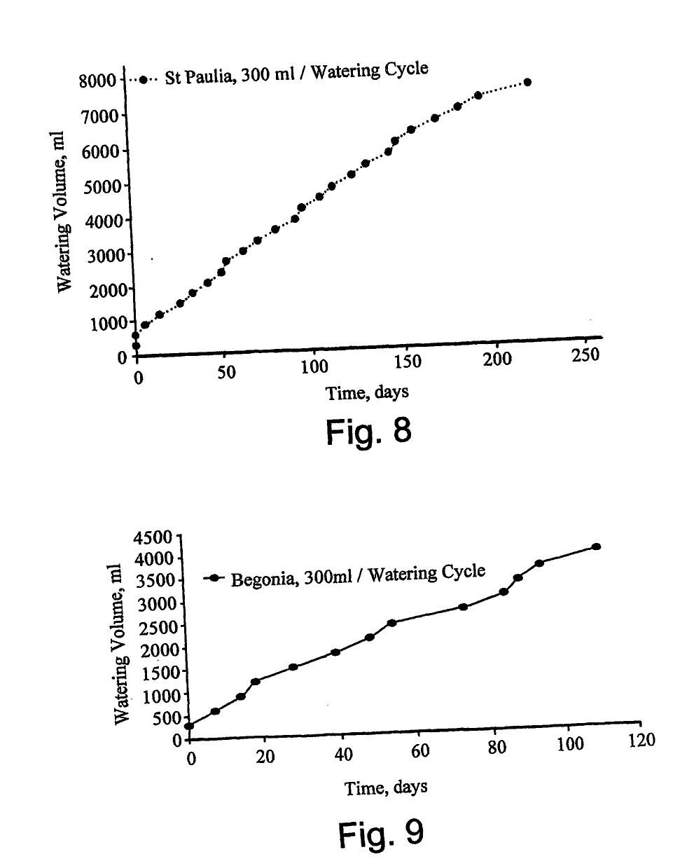

FIG. 8 shows a graph of the watering requirements of the example Saintpaulia.

FIG. 9 shows a graph of the watering requirements of the example Begonia.

Referring to FIG. 1, there is shown an irrigation system generally designated 1 which allows controlled irrigation of a plant 5.

The plant 5 is supported in a cultivating medium 10 inside a vessel 15, which in this embodiment is a plant pot having a flattened, smoothed base 17. Vessel 15 is positioned inside a larger reservoir vessel 20, containing water 25. The vessel 15 has drainage holes 30 in its base 17 which are covered over by a water permeable polymer positioned on the lower outer surface of base 17, which in this embodiment is a film of water-swollen polyurethane urea hydrogel 35.

A piece of wicking fabric 40 is positioned below the vessel 15 in contact with the hydrogel film 35. The wicking fabric acts as a water distribution device, ensuring good water contact with the hydrogel film 35, and helps create a more effective seal between the vessel base 17 and hydrogel film 35 because of its deformable character, allowing the hydrogel to conform closely to the vessel base 17.

Referring to FIG. 7, there is shown a vessel (200) in accordance with an embodiment of the present invention.

The vessel (200) is a 14 cm diameter (Stewart) plastic plantpot, (purchased from Homebase) modified so that its bottom external surface (210) is flat. The vessel (200) is contained within a reservoir (220) in the form of a 16 cm (bottom)—19 cm (top) diameter saucer (normally for 18-20 cm pots). A porous substrate in the form of a fabric layer (230) in this embodiment is shown positioned on the bottom of the reservoir (220). The fabric layer (230) is in the form of a 14 cm diameter disc of capillary matting. A 12 cm water permeable polymer shown here is a hydrogel (240) disc in this embodiment and is positioned on top of the fabric layer (230).

Experimental Section

The irrigation system shown in FIG. 1 was used to grow basil and chrysanthemum plants.

One basil and one chrysanthemum plant was purchased from local (Glasgow) supermarket. Each plant was re-potted into a 15 cm plant pot with a flattened, smoothed base. The pot base diameter was about 12 cm. Swollen polyurethane urea hydrogel membranes of about 12 cm diameter and 0.5 mm thickness were placed on top of similar diameter pieces of wicking fabric inside an open plastic reservoir (plastic picnic bowl). The polyurethane urea hydrogel composition used was PUU VI which has an aqueous swelling capacity of about 60% by weight at ambient temperatures. PUU VI hydrogel is described in, and belongs to, the polymer compositions described by European Patent, No. 0691992B1. The pots were then placed on top of the hydrogel films. The reservoirs were filled with 500 ml of tap water and refilled with 500 ml of water each time the reservoir supply was used up. Photographs were taken every 7 days and the water requirements of each plant recorded.

The following observations were made:

Basil

Initial plant height was about 15 cm. Growth rapid with leaves large and glossy. Plant very healthy in appearance. Plant grown to about 50-60 cm after 6-7 weeks. After about 4 weeks healthy white roots visible from beneath pot. No affect on plant health. Reservoir water remains clean and free from colouration. At 6-7 weeks the plant consumed about 500 ml every 24 hours in hot and sunny weather.

The irrigation system was continued for a total period of 12 weeks. Basil leaves were harvested after 8 weeks. The height of the plant after harvesting was about 75 cm. The yield of leaves was about 100 g. The height of the plant after harvesting was about 25 cm. At the end of 12 weeks, a further, approximate, 50g of leaves was harvested. Throughout the experiment, the soil in the pot remained moist and not saturated or waterlogged.

Chrysanthemum

Plant already in full bloom when purchased. Flowering expectancy therefore reduced to about 4-6 weeks from normal 6-8 weeks. Water consumption about 500 ml every 2/3 days. Flowers beginning to wilt after 4-5 weeks. Significant new green growth evident after about 6 weeks.

The plant was deadheaded after about 7 weeks. From this point the amount of new green growth accelerated significantly. After about 10 weeks, the water use increased significantly. This may have been due to the pot being knocked off the hydrogel film causing a surge in the water uptake. However, close examination of the hydrogel film at the end of the experiment revealed a small pinhole. The pinhole was probably caused by a rough area on the pot base. The pot soil was very moist but not saturated.

General

Water loss due to evaporation from open reservoir about 30-50 ml over 24 hours.

Reservoir water remains clean and free from colouration.

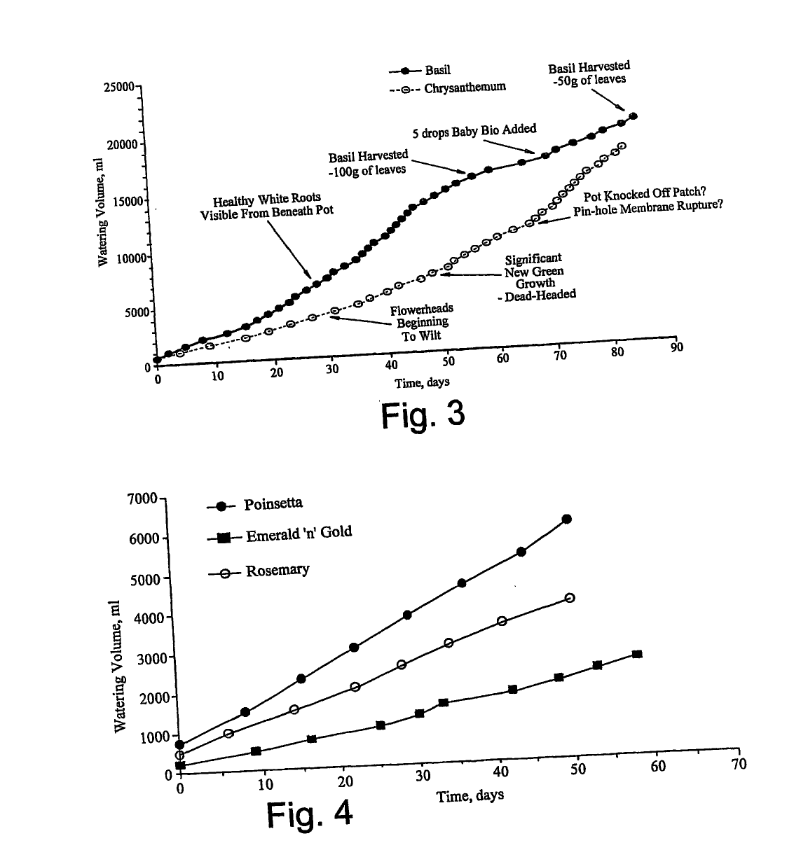

The results of the experiment are shown in FIGS. 2 and 3 which are graphs showing the water usage against time, for both basil and chrysanthemum. FIG. 3 shows the results of the experiment for the full 12 week period.

Other plants have been grown using the irrigation system as follows. Poinsettia, Emerald ‘n’ Gold shrub and Rosemary were continuously maintained in irrigation systems incorporating flat-bottomed pots, hydrogel films, wicking fabric and individual reservoirs for approximately 7 weeks. The seal between the membranes and the pots was achieved by the weight of the pot on the hydrogel surface. (Each plant had been kept watered using various forms of the irrigation system over the preceding 6 months up to the start of this experiment).

The water requirements were as follows:

Poinsettia:

Large plant uses—750 ml/week using open reservoir.

“Emerald ‘n’ Gold” Shrub:

Small plant uses—250 ml/week in standard pot plant drainage saucer.

Rosemary:

Medium cut-back plant uses—500 ml/week.

The results are shown in FIG. 4 which is a graph showing the water usage against time for all three plants.

Following completion of the above experiment, the above plants were transferred to a plastic tray containing a sheet of wicking fabric which covered the bottom surface of the tray. Each plant pot plus hydrogel film was then placed on top of the pre-wetted wicking fabric. Three litres of water was poured into the tray. This amount of water was calculated to provide around 2 weeks' supply and was based on the individual plant requirements of the individual systems. The tray system has operated successfully and continuously for 50 days. The tray requires refilling with 3 litres of water every 2-3 weeks.

It may be noted that thicker hydrogel films, for example about 1.0 mm, may be more suitable for larger and/or heavier plant pots.

FIG. 5 shows a further alternative embodiment of the present invention wherein is shown a reservoir vessel in the form of a tray 50 containing water 55.

The tray 50 is capable of holding a number of plant pots, and in this case, three plant pots 60a, 60b and 60c containing growing medium 65a, 65b and 65c and plants 70a, 70b and 70c are shown.

A wicking fabric layer 80 is shown positioned on the bottom of the tray 50 and a hydrogel film 90, having a larger surface area than those used as shown in FIGS. 1 and 3, is positioned on top of the wicking fabric layer 80.

The tray irrigation system shown in this embodiment is advantageous because suitable trays, containers and wicking fabrics are commercially available. Alternatively, however, reservoir systems of this type may be custom-designed. Pre-cut hydrogel sheets in dry or swollen form can be supplied separately or with the tray systems. Larger hydrogel sheets can also be cut down to fit specific tray sizes.

Tray systems of this type would require re-watering, for example, once a week, once every two weeks, once a month or longer depending on the water requirements of the plants and on the tray size. Plant pots may be placed anywhere on the surface of the hydrogel sheet.

The system is extremely simple and, other than the use of hydrogel sheets and flat-bottomed pots, is in keeping with conventional methods for looking after pot plants. There is no need for separate water containers/reservoirs, tubing or valves and the tray reservoir water 55 remains essentially clean and clear while the system is being used.

FIG. 6 shows an alternative embodiment of the present invention wherein is shown a container 100 with drainage holes 110 in its base. A film of polyurethane urea hydrogel 120 is adhered to the inside bottom surface of container 100 and a layer of wicking fabric 130 is positioned in intimate contact on top of the hydrogel film 120. The wicking fabric layer 130 may be pre-wetted with water.

A conventional plantpot 140 containing a plant 160 is positioned on top of the wicking fabric 130. The container 100 is positioned inside a reservoir vessel 170 containing water 180 and the plant 160 is watered by a combination of water diffusion through the hydrogel film 120 and wicking of water by capillary flow though the wicking fabric layer 130 into the plantpot 140 and cultivating medium 145 through holes 150. The wicking fabric layer 130 is kept wet by diffusion of water through the hydrogel film 120 and the driving force for this is the difference in concentration/osmotic potential etc.

This embodiment allows easy replacement of the hydrogel film 120 as required.

It is thus apparent from the foregoing embodiments of the present invention that cultivation of plants can be improved through use of a water permeable polymer resulting in the establishment of a beneficial equilibrium system governed by the plant's transpiration rate.

Advantageously, the reservoir water remained clean and free from colouration in all the foregoing experiments.

The irrigation systems according to the present invention may allow plants to be grown from seeds and reduce the frequency of watering for both long and short lived house plants. Other applications include commercial propagation and growth of plants, the transportation of plants and the storage and display of plants by retailers, nurseries and supermarkets. For example, tray systems in conservatories and either private or commercial greenhouses may incorporate the irrigation systems described herein.

Saintraulia (African Violet)

The irrigation system shown in FIG. 7 was used to grow Saintpaulia.

The Saintpaulia or African Violet is one of the most popular houseplants worldwide and is one of the ten biggest selling flowering houseplants in the UK. One of the main attractions of the Saintpaulia is their ability to flower at almost any time of the year. Generally, Saintpaulias require a warm environment, careful watering, high air humidity and regular feeding. The compost should be kept moist and it is important to avoid wetting the leaves when watering.

The Saintpaulia example houseplant was purchased from Homebase. The plant was re-potted into a 14 cm diameter Homebase (Stewart) plastic plantpot that had been modified so that the bottom external surface was completely flat, with no raised feet or lettering.

The improvised reservoir was a Homebase (Stewart) plantpot saucer with a completely flat base. The reservoir volume with the plantpot in place was 300 ml.

Procedure

A 14 cm diameter disc of capillary matting was placed in the bottom of the reservoir and a 12 cm diameter PUU VI hydrogel membrane disc was placed on top of the matting. The plantpot was then placed centrally on top of the discs (FIG. 7). The reservoir was filled with 300 ml of tap water. The plantpot was tipped to one side for a few seconds to allow water between the bottom of the plantpot and the hydrogel membrane surface. The plantpot and reservoir were then positioned on a support adjacent to a southwest facing glazed aperture. Each time the water level in the reservoir had fallen to the top surface of the hydrogel disc, a further 300 ml of water was added.

Results

The following table provides a record of the watering frequency and performance of the Saintpaulia trial, oh-AT/AV01 over a 22 week trial period.

SaintPaulia Trial, oh-AT/AV01

| | Volume of | |
|---|---|---|
| Number of Days | Water, ml | Observations/Comments |
| 0 | 300 | ˜4 weeks since purchase |
| ⅓ | 600 | A few flowers dying |
| 5 | 900 | |
| 13 | 1200 | Still some healthy flowers |
| 25 | 1500 | |
| 32 | 1800 | All flowers dead/removed |
| 41 | 2100 | Healthy leaves and growth |
| 49 | 2400 | ″ |
| 52 | 2700 | ″ |
| 62 | 3000 | ″ |
| 70 | 3300 | ″ |
| 80 | 3600 | ″ |
| 91 | 3900 | ″ |
| 94 | 4200 | ″ |
| 94 - 10 drops of Baby Bio added to soil surface | | |
| 104 | 4500 | New flower buds visible |
| 111 | 4800 | |
| 113 - 1 capful (50 ml) of Miracle Grow added to soil | | |
| surface | | |
| 121 | 5100 | 2 new flowers open |
| 127 - 1 capful (50 ml) of Miracle Grow added to soil | | |
| surface | | |
| 129 | 5400 | 7 new flowers open |
| 142 | 5700 | |
| 142 - 1 capful (50 ml) of Miracle Grow added to soil | | |
| surface | | |
| 146 | 6000 | Very healthy appearance |
| 155 | 6300 | >20 vibrant flowers in |
| | | crown |
| 155 - 1 capful (50 ml) of Miracle Grow added to soil | | |
| surface | | |
| 168 | 6600 | |
| 170 - 1 capful (50 ml) of Miracle Grow added to soil | | |
| surface | | |
| 181 | 6900 | Flowers beginning to die |
| 193 | 7200 | |
| 199 - 1 capful (50 ml) of Miracle Grow added to soil | | |
| surface | | |
| 305 - All dead flower stalks removed. New leaf growth | | |
| at centre | | |
| 211 - 1 capful (50 ml) of Miracle Grow added to soil | | |
| surface | | |
| 220 | 7500 | New flower stalks visible |

FIG. 8 illustrates the watering requirements of the example Saintpaulia.

Generally, the watering frequency is approximately every 10-14 days. A shorter 3-5 day period occurs approximately every 40-50 days. The watering frequency decreases as the flowers die. The addition of liquid plant feed does not seem to significantly affect the watering frequency.

The occurrence of regular and higher rate watering periods between longer periods of lower and more constant watering rates suggests that the Saintpaulia has been able to establish a beneficial and plant-controlled watering equilibrium over a prolonged period of time (more than 7 months and continuing).

The drop in the level of the water to the hydrogel disc surface provides a clear indication of when to re-fill the reservoir. The reservoir water remained relatively clean and clear throughout the duration of the trial with no significant discolouration and no unpleasant odour.

Begonia

The Begonia is an extremely popular and attractive flowering houseplant and has a large number of different varieties.

Procedure

The Begonia example was purchased from Homebase (Dumbarton). The plant was re-potted into a standard 13 cm plastic plantpot (Billund, Denmark) with 6×1 cm diameter drainage holes and a modified flat base. 13 cm diameter disc of capillary matting was placed in the bottom of a “300 ml” reservoir (Homebase saucer) and a 13 cm diameter PU6 (6200) hydrogel membrane disc with a thickness of −0.5 mm disc was placed on top of the matting. The reservoir was filed with 300 ml tap water. The plantpot was tipped to one side for a few seconds to allow water between the bottom of the plantpot and the hydrogel membrane surface. The plantpot and reservoir were then positioned on a support adjacent to a southwest facing glazed aperture. Each time the water level in the reservoir had fallen to the top surface of the hydrogel disc, a further 300 ml of water was added. A capful (50 ml) of an aqueous plant nutrient (Miracle Grow) was added to the top surface of the soil every 14 days.

| Number of Days | Volume of Water, ml |
|---|---|
| 0 | 300 |
| 7 | 600 |
| 14 | 900 |
| 18 | 1200 |
| 28 | 1500 |
| 39 | 1800 |
| 48 | 2100 |
| 54 | 2400 |
| 73 | 2700 |
| 84 | 3000 |
| 88 | 3300 |
| 94 | 3600 |
| 110 | 3900 |

The watering requirements of the example Begonia are illustrated in FIG. 9.

The Begonia appeared to thrive during the period of watering trial. Many new flowers opened and new and healthy green leaf growth was evident. The optimum flowering period was over the first two months. Slight variations in the watering rate, indicated by slope changes on the graph, suggest that the delivery of water to the plantpot by diffusion through the hydrogel membrane enables the plant to control its own water uptake.

Shelf-Life Trial

The effectiveness of the hydrogel membrane controlled watering system was evaluated under controlled conditions in the plant shelf-life room of a major UK houseplant grower. The following houseplants were used in study: Begonia (8 plants), Chrysanthemum (8 plants), New Guinea impatiens (5 plants) and Euphorbia (2 plants).

Controlled Conditions

| | |
|---|---|
| Temperature: | 20° C. ± 2° C. |
| Humidity: | 60% ± 10% |
| Light: | 1000 lux (12 hours/day) |

Procedure

The “shop-ready” plants used in the trial were grown for supply to the main UK supermarkets.

The Begonia, New Guinea Impatiens and Euphorbia were re-potted directly into standard 13 cm plastic plantpots (Billund, Denmark) without the addition of extra soil/compost. The plantpots were modified to have a completely flat base and 12×1 cm diameter drainage holes. The Chrysanthemums were re-potted into standard 14 cm “chrysanthemum” plastic plantpots (Billund, Denmark) with modified flat bases and 12×1 cm diameter drainage holes. To ensure the plants were uniformly and well watered before starting the trial, each plantpot was placed in a dish of water for a period of 10 minutes.

The hydrogel material used in the trial was the polyurethane hydrogel composition, PU6 (6200). The hydrogel membrane disc dimensions were 13 cm diameter and 0.5 mm thickness. The 13 cm diameter fabric discs were prepared using standard capillary matting (Homebase).

4× Begonias, 4× Chrysanthemums, 2× Euphorbias and 1× New Guinea Impatiens were watered using individual disc and reservoir (300 ml capacity plastic dishes) systems. The following multiple plant tray systems were also investigated.

| | |
|---|---|
| Tray 1 | 3 × Begonias |
| Tray 2 | 3 × Chrysanthemums |
| Tray 3 | 3 × New Guinea Impatiens |
| Tray 4 | 1 × Begonia, 1 × Chrysanthemum, 1 × New Guinea |
| | Impatiens. |

The dimensions of the plastic trays/reservoirs (Garland Products Ltd, England) were 41 cm×31 cm×4.5 cm. The trays comfortably held 2 litres of water with 3 plantpots in place.

The hydrogel and capillary matting discs were positioned inside the dish and tray reservoirs. The plantpots were placed centrally on top of the discs and then the reservoirs were filled with tap water (dish, 300 ml and tray, 2 litres). The plantpots were tipped at an angle for a few seconds to allow water between the plantpot bases and the surfaces of the hydrogel membranes. The reservoirs were re-filled when the level of water reached the top surfaces of the discs. For comparison, plants of each type were watered continuously using the normal shelf-life room capillary matting and water reservoir.

Results

Begonia

Variety: Bazan

Reference: oh-HH01

| Number of Days | Volume of Water, ml |
|---|---|
| 0 | 300 |
| 3 | 600 |
| 6 | 900 |
| 8 | 1200 |
| 13 | 1500 |
| 17 | 1800 |
| 19 | 2100 |
| 21 | 2400 |
| 24 | 2700 |
| 28 | 3000 |
| 31* | 3200 |
| 35 | 3500 |
| 38 | 3800 |
| 42 | 4100 |
| 45 | 4400 |
| 48* | 4600 |
| 52 | 4900 |
| 58 | 5200 |
| 61 | 5500 |

*200 ml water added

Begonia

Variety: Marriette

Reference: oh-HH02

| Number of Days | Volume of Water, ml |
|---|---|
| 3 | 600 |
| 6 | 900 |
| 8 | 1200 |
| 13 | 1500 |
| 17 | 1800 |
| 19 | 2100 |
| 21 | 2400 |
| 24 | 2700 |
| 28 | 3000 |
| 31 | 3300 |
| 35 | 3600 |
| 38 | 3900 |
| 42 | 4200 |
| 45* | 4400 |
| 48 | 4700 |
| 52 | 5000 |
| 58 | 5300 |
| 61 | 5600 |

*200 ml water added

Begonia

Variety: Netja dark

Reference: oh-HH03

| Number of Days | Volume of Water, ml |
|---|---|
| 0 | 300 |
| 3 | 600 |
| 6 | 900 |
| 8 | 1200 |
| 13 | 1500 |
| 17 | 1800 |
| 19 | 2100 |
| 24 | 2400 |
| 28 | 2700 |
| 31 | 3000 |
| 38 | 3300 |
| 42 | 3600 |
| 43 | 3900 |
| 45* | 4100 |
| 48 | 4400 |
| 52 | 4700 |
| 56 | 5000 |
| 61 | 5300 |

*200 ml water added

Begonia

Variety: Peggy

Reference: oh-HE04

| Number of Days | Volume of Water, ml |
|---|---|
| 0 | 300 |
| 3 | 600 |
| 6 | 900 |
| 8 | 1200 |
| 13 | 1500 |
| 16 | 1800 |
| 19** | 1900 |
| 21 | 2200 |
| 24 | 2500 |
| 28 | 2800 |
| 31 | 3100 |
| 38 | 3400 |
| 42 | 3700 |
| 45* | 3900 |
| 48 | 4200 |
| 52 | 4500 |
| 58 | 4800 |
| 62 | 5100 |

*200 ml water added,
**100 ml water added

Chrysanthemum

Variety: Patmos Time

Reference: oh-HH05

| Number of Days | Volume of Water, ml |
|---|---|
| 0 | 300 |
| 4 | 600 |
| 8 | 900 |
| 13* | 1100 |
| 17 | 1400 |
| 23 | 1700 |
| 28 | 2000 |
| 31 | 2300 |
| 38 | 2600 |
| 42 | 2900 |
| 45* | 3100 |

*200 ml water added

Chrysanthemum

Variety: Surf

Reference: oh-HH06

| Number of Days | Volume of Water, ml |
|---|---|
| 0 | 300 |
| 6 | 600 |
| 10 | 900 |
| 15 | 1200 |
| 20 | 1500 |
| 24 | 1800 |
| 29 | 2100 |
| 34 | 2400 |
| 38 | 2700 |
| 42 | 3000 |

Chrysanthemum

Variety: Patmos time

Reference: oh-HH07

| Number of Days | Volume of Water, ml |
|---|---|
| 0 | 300 |
| 4 | 600 |
| 8 | 900 |
| 15 | 1200 |
| 19 | 1500 |
| 24 | 1800 |
| 29 | 2100 |
| 34 | 2400 |
| 38* | 2600 |
| 45* | 2800 |

*200 ml water added

Chrysanthemum

Variety: Surf

Reference: oh-HH08

| Number of Days | Volume of Water, ml |
|---|---|
| 0 | 300 |
| 3 | 600 |
| 6 | 900 |
| 10 | 1200 |
| 15 | 1500 |
| 20 | 1800 |
| 24 | 2100 |
| 29 | 2400 |
| 34 | 2700 |
| 38 | 3000 |
| 42 | 3300 |

New Guinea Impatiens

Variety: Timor

Reference: oh-HH09

| Number of Days | Volume of Water, ml |
|---|---|
| 0 | 300 |
| 7 | 600 |
| 13 | 900 |
| 15 | 1200 |
| 17 | 1500 |
| 19 | 1800 |
| 21 | 2100 |
| 23 | 2400 |
| 31 | 2700 |

| Number of Days | Volume of Water, ml |
|---|---|
| 34 | 3000 |
| 38 | 3300 |
| 41 | 3600 |
| 44 | 3900 |
| 48 | 4200 |
| 52 | 4500 |
| 56 | 4800 |
| 62 | 5100 |

Euphorbia

Reference: oh-HH10

| Number of Days | Volume of Water, ml |
|---|---|
| 0 | 300 |
| 5 | 600 |
| 15 | 900 |
| 21* | 1100 |
| 28 | 1400 |
| 31 | 1700 |
| 38 | 2000 |
| 48* | 2200 |
| 61 | 2500 |

*200 ml water added

Euphorbia

Reference: oh-HH11

| Number of Days | Volume of Water, ml |
|---|---|
| 0 | 300 |
| 3 | 600 |
| 6 | 900 |
| 17* | 1100 |
| 21* | 1300 |
| 24 | 1600 |
| 31 | 1900 |
| 38 | 2200 |
| 45* | 2400 |
| 48 | 2700 |
| 52 | 3000 |
| 62 | 3300 |

*200 ml water added

Tray 1.3× Beconia

Variety: Paris Variety: Kleo Variety: Julie

Reference: oh-HH12 Reference:oh-HH13 Reference:oh-HH14

| Number of Days | Volume of Water, ml |
|---|---|
| 0 | 2000 |
| 5 | 3000 |
| 8 | 4000 |
| 15 | 6000 |
| 21 | 7000 |
| 24 | 8000 |
| 29 | 9000 |
| 34 | 10000 |
| 38 | 11000 |
| 42 | 12000 |
| 45 | 13000 |
| 52 | 14000 |
| 61 | 15000 |

Shelf-Life Trial—Comparison with Control Samples

The effectiveness of the hydrogel membrane controlled watering system was compared to watering by capillary action using capillary matting and a water reservoir. The watering of plants using capillary matting is the standard method used in the plant shelf-life rooms of UK houseplant growers. Houseplants on display in retail outlets are also normally watered using the combination of capillary matting and water reservoirs. Commercial consumer houseplant watering products predominantly involve delivering the water to the plant pots and containers by capillary action. The conditions inside the shelf-life room were as follows:

Controlled Conditions

| | |
|---|---|
| Temperature: | 20° C. ± 2° C. |
| Humidity: | 60% ± 10% |
| Light: | 1000 lux (12 hours/day) |

For the comparison study, the performance of examples of Begonia, Chrysanthemum and New Guinea Impatiens were monitored. The following standard shelf-life room quality control criteria were used:

Quality Control Criteria

1. First Flower Death (Days)

2. 50% Flower Death (Days)

3. 100% Flower Death or No Ornamental Value (Days)

The results of the control experiments are summarised in the following tables. The results quoted are average values.

| | | | | 100% Flower |
|---|---|---|---|---|
| | | First | | Death/No |
| Houseplant | Watering | Flower | 50% Flower | Ornamental |
| Type | Method | Death | Death | Value |
| Begonia | Capillary | 15 days | 42 days | N/A |
| | Matting | | | |
| Begonia | Hydrogel | 21 days | 48 days | N/A |
| | Membrane | | | |
| Chrysanthemum | Capillary | 15 days | — | 23 days |
| | Matting | | | |
| Chrysanthemum | Hydrogel | 27 days | 35 days | 39 days |
| | Membrane | | | |
| New Guinea | Capillary | 8 days | 15 days | 42 days |
| Impatiens | Matting | | | |
| New Guinea | Hydrogel | 13 days | 18 days | 55 days |
| Impatiens | Membrane | | | |

All the Begonia examples remained in flower and were relatively healthy and attractive over the 9-week period of the study.

The monitoring of the performance of houseplants watered by capillary action is a standard quality control procedure used by commercial growers. The results obtained in this study were consistent with previous data. The hydrogel diffusion controlled watering system shows an improved performance for each of the different plant types in all of the quality control criteria. The general health and appearance of the plants was improved and the flowering time and period of ornamental value were all increased. The lowering of the level of water in the reservoirs also provided a clear indication of when to re-fill without worrying above over-watering. The results suggest that, for the plant varieties used in the study, the hydrogel membrane diffusion system is a more effective and beneficial watering method than capillary delivery.

Other Plant Comparisons

Poinsettia

A Poinsettia was watered continuously on the hydrogel diffusion system for a 14 month period from the beginning of December until the end of January. During this time the plant appeared to thrive and grew from a standard 12-inch plant to a small “bush” about 24 inches in height and 36 inches across. There was significant new green leaf growth and branching and new red bracs began to grow after 12 months.

From the beginning of the trial approximately 12 poinsettia were watered continuously using capillary matting and a water reservoir. Approximately 75% of these plants had died within 3 months. The remaining plants lived for periods of between 6 months and 12 months but displayed only a small amount of new growth and generally were of poor appearance and health.

Kalanchoe

Two plant examples were watered using the hydrogel membrane diffusion system and remained healthy and in flower for the 12 week period of the trial. The reservoir water remained clean and clear throughout this time.

A third plant was watered by placing the pot inside a reservoir which was kept continuously full of water. After around 1 week the reservoir water had turned yellow-brown in colour. Almost immediately the plant leaves began to rise up and away from the water. The-number and quality of the flowers began to deteriorate rapidly so that after only 3-4 weeks the plant had fewer flowers and was noticeably less attractive than the two plants watered using the hydrogel membrane system. At 12 weeks the plant had a very poor appearance with only a few weakly coloured flowers. The reservoir water was brown in colour and gave off an unpleasant odour. When the plant was removed from the pot there was clear evidence of root-rot.

1. An apparatus for cultivating plants, which apparatus comprises a vessel for receiving a plant cultivating medium, the vessel wall having one or more apertures of which at least one is substantially occluded by a water permeable polymer for controllably introducing an aqueous medium into the vessel, and a reservoir for the aqueous medium.

2. An apparatus according to claim 1 wherein the water permeable polymer is a water swellable polymer.

3. An apparatus according to any preceding claim wherein the water permeable polymer is a hydrogel.

4. An apparatus according to any preceding claim wherein the water permeable polymer is in a form selected from the group consisting of a film, membrane, layer and sheet.

5. An apparatus according to claim 4 wherein the water permeable polymer has a thickness of about 0.001 mm to 5.0 mm.

6. An apparatus according to any preceding claim, the apparatus further comprising a support layer for the water permeable polymer, the support layer comprising a porous material.

7. An apparatus according to any preceding claim, the apparatus further comprising a layer of porous substrate in cooperation with the water permeable polymer, the porous substrate providing an indirect means of communication between the aqueous medium in the reservoir and the water permeable polymer.

8. An apparatus according to any preceding claim wherein the water permeable polymer is positioned in intimate contact with a lower surface of the vessel.

9. An apparatus according to any preceding claim wherein the water permeable polymer forms a seal with the aperture(s) of the vessel wherein the water permeable polymer is constructed and arranged to support transport of aqueous medium through the thickness of the polymer by diffusion and entry of aqueous medium into the vessel through hydraulic or capillary flow is prevented.

10. An apparatus according to claim 9 wherein the seal is formed using glue, sealant, adhesive, grease or by the weight of the vessel on the water permeable polymer.

11. An apparatus according to any preceding claim wherein the water permeable polymer is shaped to conform to and is supported by an inside surface of the vessel.

12. A vessel for use in the apparatus of claim 1, the vessel comprising one or more apertures of which at least one aperture is substantially occluded by a water permeable polymer.

13. An irrigation system for cultivating plants, the irrigation system comprising a vessel suitable for containing a plant cultivating medium in cooperation with a reservoir for aqueous medium wherein said vessel comprises one or more apertures of which at least one aperture is substantially occluded by a water permeable polymer and the water permeable polymer is constructed and arranged to support transport of the aqueous medium through the thickness of the polymer by diffusion into the cultivating medium.

14. Use of a water permeable polymer for transferring water or an aqueous solution into a plant cultivating medium by diffusion.

15. A kit for use in the apparatus of claim 1, the kit comprising a film, membrane, layer or sheet of water-permeable polymer packaged in a water-tight package.

16. A kit as claimed in claim 15, wherein the package is UV occlusive.
